(19) United States
(12) Patent Application Publication
(10) Pub. No.: US 2006/0204251 A1
(43) Pub. Date: Sep. 14, 2006

(54) Setting parameter modifying apparatus and image forming apparatus comprising same

(75) Inventor: Dong-cheol Ahn, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/362,124

(22) Filed: Feb. 27, 2006

(30) Foreign Application Priority Data
Mar. 8, 2005 (KR) 2005-19093

(51) Int. Cl. G03G 15/00; G03G 15/20

(52) U.S. Cl. 399/12; 399/69

(57) ABSTRACT

A setting parameter modifying apparatus, the apparatus including a developing cartridge, containing consumables having certain characteristics, detachably installed in a main body of an image forming apparatus, containing a constituent element to operate on the consumables; and a setting parameter modifying element, installed on the developing cartridge, to modify setting parameters of the constituent element of the image forming apparatus such that the constituent element operates on the consumables according to the characteristics thereof.

### CROSS-REFERENCE TO RELATED APPLICATIONS

This application claims the benefit of Korean Application No. 2005-19093, filed Mar. 8, 2005, in the Korean Intellectual Property Office, the disclosure of which is incorporated herein by reference.

### BACKGROUND OF THE INVENTION

1. Field of the Invention

An aspect of the present invention relates to an electro-photographic image forming apparatus. More specifically, the invention relates to a setting parameter modifying apparatus and an image forming apparatus comprising a setting parameter modifying apparatus in which setting parameters of various constituent elements of the image forming apparatus are modified using a developing cartridge that is mounted on the image forming apparatus in a replaceable manner with a certain lifespan.

2. Description of the Related Art

Generally, an electro-photographic image forming apparatuses, such as laser beam printers, digital photocopiers, digital facsimile machines, multi-operational devices, and the like, form electrostatic latent images by exposing image data that is obtained from documents to a photosensitive drum charged with a certain electrical potential, and spread developer on a certain portion of the photosensitive drum where electrostatic latent images are formed so as to form visible images. Then, the visible images are transferred onto printing media by a transferring device, and fixed to the media by an application of heat and pressure. As a result, desired images are printed.

In such an electro-photographic image forming apparatus, there are some constituent elements having limited lifespans (hereafter, referred to as consumables), such as a developer containers, which contain developer, photosensitive drums, and developing rollers to supply developer to the photosensitive drums. Recently, for user convenience when replacing consumables, the developer containers, photosensitive drums, and developing rollers have been integrated in one body in the form of a cartridge.

FIG. 1 is a configuration showing a major portion of an electro-photographic image forming apparatus applying an example of a developing cartridge. With reference to FIG. 1, the printing process of a conventional image forming apparatus will be explained.

When laser beams are scanned from a laser scanning unit (LSU) 120 on the photosensitive drum 112, the surface of which is charged with a certain electrical potential by a charging device 111, an electrostatic latent image is formed on a certain area of the surface of the photosensitive drum 112. A developing roller 113 spreads developer on a certain area of the photosensitive drum 112 where the electrostatic latent image is formed, and a visible image is formed as a result. The visible image formed on the photosensitive drum 112 is transferred onto a printing medium P that is supplied by a transferring device 114. Reference numeral “115” denotes an agitator to agitate developer, and reference numeral “116” denotes a supply roller to supply developer to the developing roller 113. Reference numeral “117” denotes a cleaning blade to remove the developer that is not transferred onto the printing medium and that remains on the photosensitive drum 112, and reference numeral “118” denotes waste developer removed by the cleaning blade 117. The visible image transferred onto the printing medium P is fixed by a fixing unit 130 that comprises a heating roller 132 containing a heating source inside and a pressing roller 134.

On the other hand, the LSU 120 includes a laser diode 121 as a light source, a rotary polygon mirror 122, and a driving motor 123 for driving the rotary polygon mirror 122. As shown in FIG. 1, each constituent element of the developing cartridge 100 is installed inside a resin housing 110.

When the developer of such an integrated developing cartridge 100 is used up, a user separates the cartridge from the image forming apparatus and mounts a newly purchased developing cartridge on the image forming apparatus. However, diverse models of developing cartridges are manufactured by different companies. Thus, when a new developing cartridge is to be replaced, models of the consumables inside the old developing cartridge may be different from those of a new developing cartridge at the point of replacement.

If the internal parts of the old and new developing cartridges are different at the point of replacement, the setting parameters of the image forming apparatus that are optimally adapted to the previous parts may not be suitable for the parts of the new developing cartridge, thereby degrading printing quality. Accordingly, in order to obtain optimal printing quality, the setting parameters need to be modified so as to be suitable for the new parts.

A developing cartridge may be classified into a model having a Customer Replacement Unit Memory (CRUM) and a model not having a CRUM. Generally, a CRUM stores unique information of a product such as lifespan of developer and photosensitive drum, a serial number given in the manufacturing process of the product, and the like. However, in the case of a developing cartridge that does not have a CRUM, no particular methods exist under which the specifications of a product may be modified so as to be suitable for the replaced parts if the characteristics are different when comparing the internal consumables of the developing cartridge with those of the initial models. With these devices, once the software and hardware configurations of an image forming apparatus are determined, the configurations cannot be easily modified after being manufactured, except in those cases where new parts have sufficiently similar specifications or characteristics as the replaced parts. In any other cases, such that consumables of a new and an old developing cartridge do not have similar specification or characteristics, optimal printing quality cannot be obtained.

In contrast, in the case of a developing cartridge that has a CRUM, if the characteristics are different when comparing the internal consumables of a new developing cartridge with those of initial models, the information on the parts is stored in the CRUM in order to modify the specifications so as to be suitable for the changed parts, so that the software of an image forming apparatus may be modified when a developing cartridge is mounted on the image forming apparatus. However, in a case where a CRUM in the form of a semiconductor chip is attached to a developing cartridge, material costs increase. In addition, additional circuits are installed in order to modify the software of the image forming apparatus, thereby ultimately increasing production costs.

### SUMMARY OF THE INVENTION

An aspect of the present invention solves the above and/or other drawbacks in the art. Another aspect of the invention is to provide a setting parameter modifying apparatus and an image forming apparatus comprising the same, in which, even though the parts of a new cartridge have different specifications from those of the internal consumables of an old developing cartridge, the parts may be used in the existing image forming apparatus when developing cartridges are replaced.

According to one aspect of the invention for achieving the aspects, there is provided a setting parameter modifying apparatus, the apparatus comprising a developing cartridge, containing consumables having certain characteristics, detachably installed in a main body of an image forming apparatus, containing a constituent element to operate on the consumables; and a setting parameter modifying element, installed on the developing cartridge, to modify setting parameters of the constituent element of the image forming apparatus such that the constituent element operates on the consumables according to the characteristics thereof.

In an aspect of the invention, the setting parameter modifying element comprises a resistor element.

According to one aspect of the invention, the consumables of the developing cartridge include a developer, and the setting parameter is the optical output power of a laser diode that scans laser beams on the photosensitive drum. The resistor element modifies the optical output power of the laser diode.

In addition, the setting parameter modifying apparatus comprises a controller that includes a laser diode power supply to supply power to the laser diode and is connected to the setting parameter modifying element so as to exchange signals when the developing cartridge is mounted on the image forming apparatus main body. The resistor element may be installed between the laser diode power supply and the laser diode.

According to another embodiment of the invention, the consumables of the developing cartridge include a photosensitive drum, and the setting parameter is the fixing temperature of a fixing unit that fixes developer onto a printing medium. The resistor element modifies the fixing temperature. In addition, the setting parameter modifying apparatus comprises a controller that includes a lamp power controller to supply power to the fixing unit and is connected to the setting parameter modifying element so as to exchange signals when the developing cartridge is mounted on the image forming apparatus main body.

In addition, the fixing unit includes a heating roller provided with a lamp as a heat source and a temperature detecting device to detect the temperature around the heating roller, and the resistor element may be installed between the controller and the temperature detecting device.

The above and/or other aspects are also accomplished by an image forming apparatus having the following configurations. The image forming apparatus comprises a developing cartridge, a laser scanning unit, a fixing unit, a setting parameter modifying element, and a controller.

The developing cartridge includes a photosensitive drum, a developing roller, and developer that have certain lifespans, forms a visual image by spreading developer onto an electrostatic latent image formed on the photosensitive drum, and is installed at an image forming apparatus main body in a detachable manner. The laser scanning unit includes a laser diode as a light source, and forms an electrostatic latent image by scanning laser beams emitted from the laser diode onto the photosensitive drum. The fixing unit fixes an image on a printing medium by applying high temperature heat and pressure after the visual image formed by the developing cartridge is transferred onto the printing medium. The setting parameter modifying element is installed at one side of the developing cartridge, and modifies the setting parameters of the laser scanning unit or the fixing unit in a case where either one of the photosensitive drum or developer of a new developing cartridge to be replaced is different from those of an old developing cartridge. The setting parameter modifying element may be a resistor element. The controller is connected to the setting parameter modifying element so as to exchange signals when the developing cartridge is mounted on the main body.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a configuration showing a major portion of a conventional electro-photographic image forming apparatus;

FIG. 2 is a cross-sectional view of a developing cartridge provided with a setting parameter modifying element according to one embodiment of the invention;

FIG. 3 is an elevation view of a setting parameter modifying element according to one embodiment of the invention;

FIG. 4 is an elevation view of a setting parameter modifying element according to another embodiment of the invention;

FIG. 5 is a block diagram showing a configuration of a setting parameter modifying according to one embodiment of the invention; and

FIG. 6 is a block diagram showing a configuration of a setting parameter modifying apparatus according to another embodiment of the invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

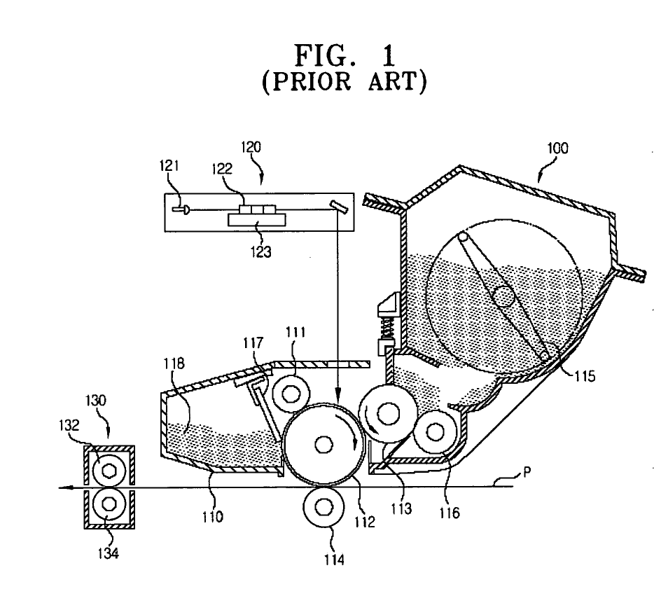

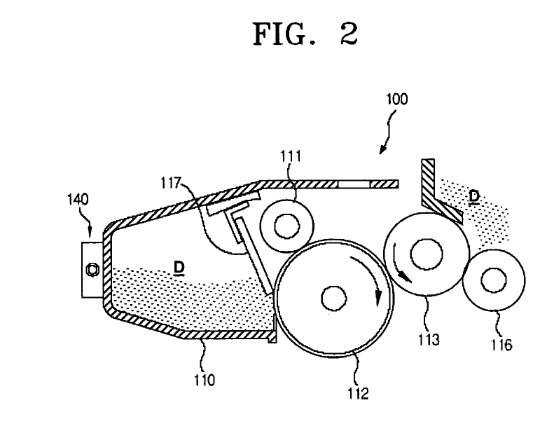

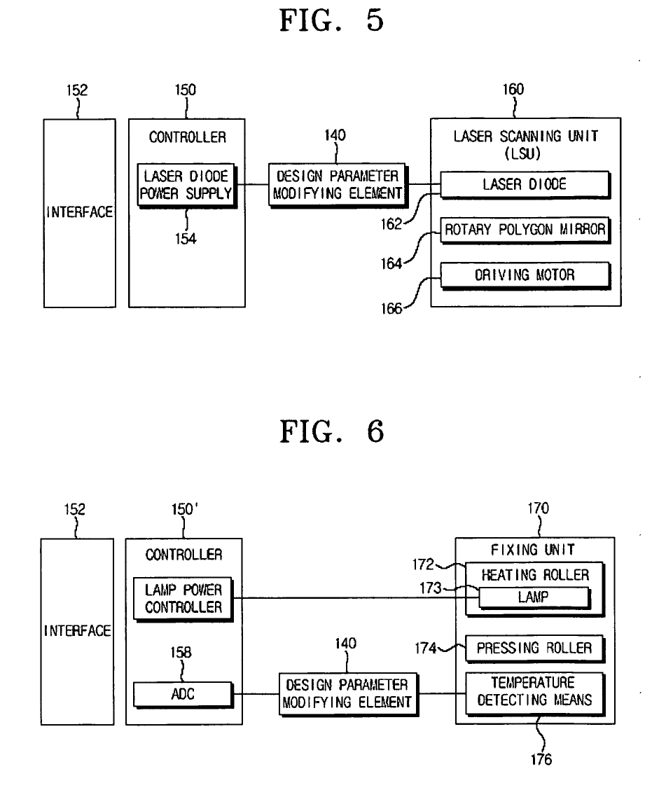

Referring to FIGS. 2 and 5, a setting parameter modifying apparatus comprises a developing cartridge 100, a setting parameter modifying element 140 installed at one side of the developing cartridge 100, and a controller 150 (see FIG. 5). The developing cartridge 100 is detachably installed in an image forming apparatus main body (not shown), and developer D, a charging roller 111, a photosensitive drum 112, a developing roller 113, a supply roller 116, and a cleaning blade 117 are installed in the resin housing 110. Because the developing cartridge 100 has the same configuration as the developing cartridge disclosed in FIG. 1, a description thereof will be omitted for the sake of brevity.

The setting parameter modifying element 140 is installed at one side of the outer surface of the housing 110 of the developing cartridge 100. As shown in FIG. 2, the setting parameter modifying element 140 is installed on a front surface of the developing cartridge 100. However, this arrangement is not limiting and the setting parameter modifying element 140 may be installed at other positions of the developing cartridge 100. That is, a setting parameter modifying element 140 can be installed at the side, top, bottom, or rear surfaces.

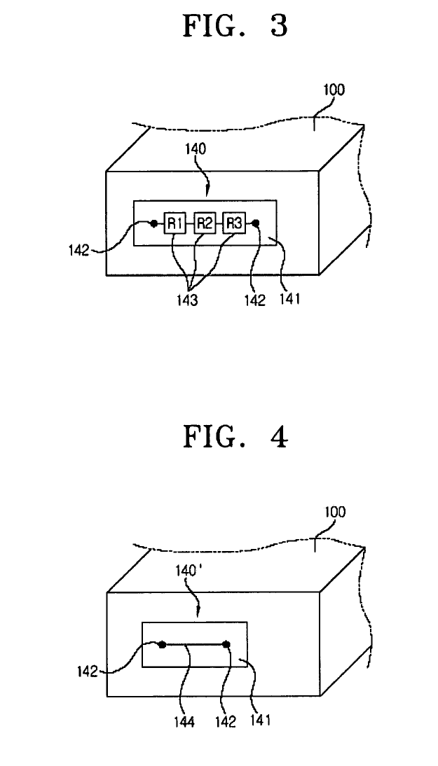

Referring to FIG. 3, a setting parameter modifying element 140 includes a circuit board 141 and a series of resistor elements 143 installed between two contact points 142 of the circuit board 141. Here, it is understood that the resistor elements 143 may be replaced by other electrical elements to achieve a similar effect and that the discussion of the use of the resistor elements 143 is not intended to limit the present invention. The resistor elements 143 are applied when the consumables inside a developing cartridge 100 to be replaced have different specifications from those of the developing cartridge 100 (hereinafter referred to as a modified product) to which the setting parameter modifying element 140 is attached. The resistor elements 143 may be connected in series or in parallel and the number of elements is not limited to the three shown in FIG. 3.

When the developing cartridge 100, having the setting parameter modifying element 140 attached thereto, is mounted on the image forming apparatus main body (not shown), the setting parameter modifying element 140 of the invention to which the resistor elements 143 are applied is connected to a contacting point terminal (not shown) of the controller 150 that is implemented in a board to modify setting parameters such as the optical output power of the laser diode 162 (see FIG. 5) and the fixing temperature of the heating roller 172 (see FIG. 6) so as to be suitable for the new parts.

Where consumables, which are inside a developing cartridge 100 to replace another developing cartridge that is already in use, have the same specifications as those of the other developing cartridge (i.e., the developing cartridge 100 is not a modified product), a setting parameter modifying element 140′ disclosed in FIG. 4 is applied. As shown in FIG. 4, the setting parameter modifying element 140′ includes a circuit board 141 and a conductive wire 144 installed between two contact points 142 of the circuit board 141. Again, it is understood that the conductive wire 144 may be replaced by another electrical element to achieve a similar effect and that the discussion of the use of the conductive wire 144 is not intended to limit the present invention.

When the developing cartridge 100 is mounted on the image forming apparatus, the controller 150, 150′ (referring to FIGS. 5 and 6) is connected to the setting parameter modifying element 140, 140′, respectively, in a manner that allows for signal communication between the controller 150 and the setting parameter modifying element 140 or the controller 150′ and the setting parameter modifying element 140′. This will be explained in detail below.

Hereafter, a setting parameter modifying apparatus according to one embodiment of the invention will be explained. Referring to FIG. 5, a setting parameter modifying apparatus according to the embodiment comprises a controller 150, a laser beam scanning unit 160, and a setting parameter modifying element 140. The controller 150 analyzes printing data received from a computer through an interface 152, and controls each constituent element of the image forming apparatus so as to perform general printing operations such as paper feeding, charging, exposing, transferring, and fixing. The controller 150 includes a laser diode power supply 154. The controller 150 supplies power to a laser diode 162 in a default value through the laser diode power supply 154.

The laser beam scanning unit (LSU) 160 forms a latent image, i.e., an electrostatic latent image, by scanning laser beams (light) onto the photosensitive drum 112 (see FIG. 2) of the developing cartridge 100 according to electrical signals from the controller 150, and includes a laser diode 162, a rotary polygon mirror 164, and a driving motor 166. A general semiconductor laser is used as a laser diode 162 that emits laser beams of a certain optical output power (approximately 1-5 mW) in a 787 nm wavelength (red color). Generally, the optical output power arriving at the photosensitive drum 112 is approximately 0.5˜0.8 mW considering the efficiencies of the lenses and reflecting mirrors. The rotary polygon mirror 164 is rotated at a certain speed by the driving motor 166, and reflects the laser beams emitted from the laser diode 162 to the photosensitive drum 112. A synchronization signal (beam detection) signifying the start of beam scanning is generated according to the rotation of the rotary polygon mirror 164. Thus, the controller 150 may transmit video signals synchronized in substantially every horizontal line to the laser diode 162.

The optical output power of the laser diode 162 to form electrostatic latent images on the photosensitive drum 112 may vary according to the type of photosensitive drum 112 that is used, and the optical output power is determined by the default power source of the laser diode power supply 154. That is, the optical output power of the laser diode 112 varies according to the sensitivity of the photosensitive drum 112, and the sensitivity of the photosensitive drum 112 relates to the rotation speed of the photosensitive drum. The higher the sensitivity of the photosensitive drum 112, the less optical output power of laser diode 162 is needed in order to form electrostatic latent images. However, if the sensitivity of the photosensitive drum 112 is low, electrostatic latent images may be formed when the photosensitive drum is scanned by a higher optical output power of the laser diode 162. Therefore, in order to reduce the waiting time after sending a print command and to reduce power consumption, photosensitive drums 112 with high sensitivities have been recently developed.

The setting parameter modifying element 140 is installed between the laser diode power supply 154 of the controller 150 and the laser diode 162 of the LSU 160 when the developing cartridge 100 is mounted on the image forming apparatus main body (not shown).

Operations of the setting parameter modifying apparatus will be explained below.

First, where a modified product in which the photosensitive drum of a developing cartridge 100 to which the setting parameter modifying element 140 is attached has a higher sensitivity than that of the photosensitive drum in the developing cartridge to be replaced or substituted for, the resistor elements 143 shown in FIG. 3 are applied as a setting parameter modifying element 140. The laser diode power supply 154 supplies a similar amount of voltage as was supplied previously. However, lesser amounts of current are supplied to the laser diode 162 than before due to the resistor elements 143. Accordingly, the optical output power of the laser diode 162 is lower than before the changing of the developing cartridge 100. Therefore, laser beams having less optical output power than before are scanned onto the highly sensitive photosensitive drum 112 of a new developing cartridge 100, and electrostatic latent images having a similar density as before are formed on the photosensitive drum 112.

On the other hand, values determined by experiment are applied to the resistance values of the resistor elements 143. That is, the optimal output power of a laser beam to form an electrostatic latent image on a new photosensitive drum 112 is calculated, and the resistance values of the resistor elements 143 are adjusted so as to output the calculated optical output power.

However, where the photosensitive drum 112 of the developing cartridge 100 has the same specifications as those of the photosensitive drum in the developing cartridge to be replaced or substituted for (i.e., a case where a modified product is not being used), the wire 144 in FIG. 4 is applied as a setting parameter modifying element 140. In this case, the wire 144 only performs a switching operation that electrically connects the laser diode power supply 154 and the laser diode 162. Therefore, laser beams having the same optical output power as before are scanned onto the photosensitive drum 112.

As shown in FIG. 6, a setting parameter modifying apparatus according to another embodiment of the invention comprises a controller 150′, a fixing unit 170, and a setting parameter modifying element 140.

Here, the fixing unit 170 dissolves the developer that is transferred onto a printing medium by applying high temperature heat (approximately 150° C.-200° C.), and fixes the developer onto the printing medium by an application of pressure. The fixing unit 170 includes a heating roller 172 that contains a lamp 173 as a heat source to generate high temperatures both inside and outside of the heating roller 172, a pressing roller 174 that is installed to face the heating roller 172 to be positioned to press the printing medium at a uniform pressure along a longitudinal length of the pressing roller 174, and a temperature detecting device 176.

The temperature detecting device 176 detects the temperature around the surface of the heating roller 172. Generally, a heat-detecting sensor such as a thermistor is used as the temperature detecting device 176. However, it is understood that this embodiment is not limited to the use of thermistors and that other devices may be used to detect temperature around the surface of the heating roller. The temperature detecting device 176 exchanges information with an analog digital converter (ADC) of the controller 150. On the other hand, the temperature detecting device 176 has a characteristic in that the measured temperature varies according to the resistance values around the heating roller 172 that is to be measured. As such, the higher the resistance value is around the roller, the lower the measured temperature becomes.

The temperature of the heating roller 172 that is applied to dissolve the developer attached to a printing medium differs according to the type of developer used. That is, the fixing temperature of the developer differs according to the developer type. Where the fixing temperature of developer is high, the lamp 173 of the heating roller 172 is required to consume more electrical power. Therefore, developer that may be fixed at lower temperatures has been recently developed.

The controller 150′ according to the embodiment includes a lamp power controller 156 and an ADC 158. The lamp power controller 156 supplies power to control the heating temperature of the lamp 173, which, as noted above, is a heat source of the fixing unit 170. The ADC 158 exchanges signals with the temperature detecting device 176 of the fixing unit 170, and converts the analog values of the temperature data transmitted by the temperature detecting device 176 into digital values so that the controller 150′ may recognize them.

The setting parameter modifying element 140 is installed between the ADC 158 of the controller 150 and the temperature detecting device 176 of the fixing unit 170 when the developing cartridge 100 is mounted on the image forming apparatus main body (not shown).

Hereinafter, operations of the setting parameter modifying apparatus according to another embodiment of the invention will be explained.

First, where a developing cartridge 100, to which the setting parameter modifying element 140 is attached, is a modified product that has developer whose fixing temperature is lower than that of the existing developer, the resistor elements 143 in FIG. 3 are applied as a setting parameter modifying element 140. The resistance value of the environment neighboring the heating roller 172 increases due to the resistor elements 143. Therefore, the temperature measured by the temperature detecting device 176 decreases.

Accordingly, the temperature detecting device 176 transmits temperature data that is lower than the temperature data transmitted before the developing cartridge 100 was replaced. More particularly, the controller 150 obtains temperature data through the ADC 158, and controls the heating temperature of the lamp 173 through the lamp power controller 156. Therefore, the heating temperature of the heating roller 172 measured after the developing cartridge has been replaced becomes lower than the heating temperature of the heating roller 172 before the replacement. Accordingly, the developer of the new developing cartridge 100 is fixed at a temperature lower than before.

Values determined by experiment are applied to the resistance values of the resistor elements 143. That is, the optimal fixing temperature at which new developer may be fixed onto a printing medium is calculated, and the resistance values of the resistor elements 143 are adjusted to output the calculated fixing temperature.

However, in a case where the developer of a developing cartridge 100 to be replaced or substituted for has the same specifications as those of the developer of the developing cartridge 100 (i.e., where a modified product is not being used), the wire 144 in FIG. 4 is applied as a setting parameter modifying element 140. In this case, the wire 144 only performs a switching operation that electrically connects the ADC 158 and the temperature detecting device 176. Therefore, the heating roller 172 heats the developer at the same temperature as before.

As is described above, according to a setting parameter modifying apparatus and an image forming apparatus comprising the same according to the invention, only hardware constituent elements such as a setting parameter modifying element are installed in a developing cartridge, so that, when replacing a developing cartridge that is used up, the developing cartridge may be used even though the internal parts are different from the parts being replaced.

Therefore, a developing cartridge having a photosensitive drum and developer that are improved in their performance may be applied to an existing image forming apparatus without being provided with a CRUM. As a result manufacturing costs may be reduced.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A setting parameter modifying apparatus, the apparatus comprising:
a developing cartridge, containing consumables having certain characteristics, detachably installed in a main body of an image forming apparatus, containing a constituent element to operate on the consumables; and
a setting parameter modifying element, coupled to the developing cartridge, to modify setting parameters of the constituent element of the image forming apparatus such that the constituent element operates on the consumables according to the characteristics thereof.

2. The apparatus as claimed in claim 1, wherein the setting parameter modifying element comprises a resistor element.

3. The apparatus as claimed in claim 2, wherein, when the consumables of the developing cartridge include a photosensitive drum, one of the setting parameters to be set is an optical output power of a laser diode that scans laser beams onto the photosensitive drum, the resistor element modifying the optical output power of the laser diode.

4. The apparatus as claimed in claim 3, further comprising a controller, including a laser diode power supply to supply power to the laser diode, connected to the setting parameter modifying element so as to exchange signals with the setting parameter modifying element when the developing cartridge is mounted on the image forming apparatus main body, wherein the resistor element is installed between the laser diode power supply and the laser diode.

5. The apparatus as claimed in claim 2, wherein, when the consumables of the developing cartridge include developer, one of the setting parameters to be set is a fixing temperature of a fixing unit that fixes developer onto a printing medium, the resistor element modifying the fixing temperature.

6. The apparatus as claimed in claim 5, further comprising a controller, including a lamp power controller to supply power to the fixing unit, connected to the setting parameter modifying element so as to exchange signals with the setting parameter modifying element when the developing cartridge is mounted on the image forming apparatus main body.

7. The apparatus as claimed in claim 6, wherein the fixing unit comprises a heating roller provided with a lamp as a heat source and a temperature detecting device to detect temperatures around the heating roller, the resistor element being installed between the controller and the temperature detecting device.

8. The apparatus as claimed in claim 1, wherein the setting parameter modifying element is installed at one side of the developing cartridge.

9. An image forming apparatus, comprising:
a developing cartridge, including a photosensitive drum and developer, each of which has certain characteristics, to form a visual image by spreading the developer on an electrostatic latent image formed on the photosensitive drum, the developing cartridge being detachably installed in a main body of an image forming apparatus;
a laser scanning unit to form an electrostatic latent image by scanning laser beams onto the photosensitive drum;
a fixing unit to fix an image on a printing medium, onto which the visual image formed by the developing cartridge is transferred, by applying heat and pressure to the visual image;
a setting parameter modifying element coupled to the developing cartridge to modify setting parameters of the laser scanning unit or the fixing unit to operate according to the characteristics of the photosensitive drum and/or the developer; and
a controller connected to the setting parameter modifying element so as to exchange signals with the setting parameter modifying element when the developing cartridge is mounted on the main body.

10. The apparatus as claimed in claim 9, wherein the setting parameter modifying element comprises a resistor element.

11. The apparatus as claimed in claim 10, wherein one of the setting parameters to be set is an optical output power of the laser diode, the resistor element modifying the optical output power of the laser diode.

12. The apparatus as claimed in claim 11, wherein the controller includes a laser diode power supply to supply power to the laser diode, and the resistor element is installed between the laser diode power supply and the laser diode.

13. The apparatus as claimed in claim 10, wherein one of the setting parameters to be set is a fixing temperature of the fixing unit, the resistor element modifying the fixing temperature.

14. The apparatus as claimed in claim 13, wherein the fixing unit comprises a heating roller provided with a lamp as a heat source and a temperature detecting device to detect a temperature of the heating roller, and the resistor element is installed between the controller and the temperature detecting device.

15. The apparatus as claimed in claim 9, wherein the characteristics of the photosensitive drum and the developer are the respective lifespans of each.

16. The apparatus as claimed in claim 9, wherein the laser scanning unit comprises a laser diode from which the laser beams to scan the electrostatic latent image on the photosensitive drum are emitted.

17. A setting parameter modifying apparatus to be used with an image forming apparatus including a laser scanning unit to form an electrostatic latent image and a fixing unit to fix the image on a printing medium by an application of heat and pressure to the image, the apparatus comprising:
a developing cartridge, containing consumables having certain characteristics, detachably installed in the image forming apparatus, the consumables being acted on by the laser scanning unit and/or the fixing unit; and
a setting parameter modifying element, coupled to the developing cartridge, to modify setting parameters of the laser scanning unit and/or the fixing unit such that the laser scanning unit and/or the fixing unit operates on the consumables according to the characteristics thereof.

18. The apparatus as claimed in claim 17, wherein the consumables of the developing cartridge comprise:
a photosensitive drum on which the electrostatic latent image is formed, wherein one of the parameters to be set is an optical output power of a laser diode that scans laser beams onto the photosensitive drum, the setting parameter modifying element modifying the optical output power of the laser diode; and
developer, wherein another of the parameters to be set is a fixing temperature of a fixing unit that fixes developer onto the printing medium, the setting parameter modifying element modifying the fixing temperature.

19. The apparatus according to claim 18, further comprising a heating roller to heat the developer to the fixing temperature, wherein, when the setting parameter modifying element modifies the optical output power of the laser diode, the setting parameter modifying element decreases an amount of current supplied to the laser diode, and, when the setting parameter modifying element modifies the fixing temperature, the setting parameter modifying element increases resistance around the heating roller to lower a temperature around the heating roller.

20. An image forming apparatus including a laser scanning unit to form an electrostatic latent image and a fixing unit to fix the image on a printing medium by an application of heat and pressure to the image, the apparatus comprising:
a developing cartridge, including a photosensitive drum and developer, each of which has certain characteristics, the developing cartridge being detachably installed in the image forming apparatus; and
a setting parameter modifying element coupled to the developing cartridge to modify setting parameters of the laser scanning unit and/or the fixing unit to operate according to the characteristics of the photosensitive drum and/or the developer.

21. A setting parameter modifying apparatus to be used with an image forming apparatus including a plurality of constituent elements, the apparatus comprising:
a first developing cartridge, containing consumables having certain characteristics, to be detachably installed in the image forming apparatus, the consumables being acted on by the laser scanning unit and/or the fixing unit;
a second developing cartridge, containing consumables having certain characteristics, to be detachably installed in the image forming apparatus, the consumables being acted on by the laser scanning unit and/or the fixing unit; and
a setting parameter modifying element, coupled to the second developing cartridge, to modify setting parameters of one or more of the constituent elements of the image forming apparatus such that the one or more of the constituent elements operates on the consumables according to the characteristics thereof, when the second developing cartridge replaces the first developing cartridge and when the characteristics of the consumables of the second developing cartridge are different from those of the first developing cartridge.

22. A method of operating an image forming apparatus, including a plurality of constituent elements, the method comprising replacing a first developing cartridge, including consumables having certain characteristics on which the constituent elements operate, with a second developing cartridge, including consumables having certain characteristics on which the constituent elements operate and a setting parameter modifying element to modify setting parameters of one or more of the plurality of constituent elements of the image forming apparatus if the characteristics of the consumables of the second developing cartridge differ from those of the first developing cartridge.
